(19) United States
(12) Patent Application Publication
(10) Pub. No.: US 2015/0354575 A1
(43) Pub. Date: Dec. 10, 2015

(54) PUMP UNIT

(71) Applicant: GRUNDFOS HOLDING A/S, Bjerringbro (DK)

(72) Inventors: Michael Egelund OLSEN, Silkeborg (DK); Christian SCHULDT, Reinfeld (DE)

(73) Assignee: GRUNDFOS HOLDING A/S, Bjerringbro (DK)

(21) Appl. No.: 14/655,365

(22) PCT Filed: Dec. 12, 2013
(86) PCT No.: PCT/EP2013/076365

§ 371 Date: Jun. 25, 2015

(30) Foreign Application Priority Data
Dec. 27, 2012 (EP) 12199514.6

(51) Int. Cl. F04D 13/06; F04D 17/08; F04D 25/06; H02K 9/22; F04D 29/28; F04D 29/58; H02K 11/00; H02K 5/22; F04D 1/00; F04D 29/22

(52) U.S. Cl. CPC F04D 13/0693; F04D 1/00; F04D 17/08; F04D 25/0693; F04D 29/22; F04D 29/28; F04D 29/5806; H02K 11/0073; H02K 5/225; H02K 9/22

(57) ABSTRACT

A pump assembly has an electric drive motor arranged in a stator housing (8) and has an electronics housing (18) arranged on the outer side of the stator housing (8). The electronics housing (18), in a section of an outer wall (24; 128) which does not face the stator housing (8), includes at least one opening (92; 144). At the at least one opening (92; 144) a heat distributor (84; 142), arranged in the inside of the electronics housing (18), is situated.

### CROSS REFERENCE TO RELATED APPLICATIONS

This application is a United States National Phase Application of International Application PCT/EP2013/076365 filed Dec. 12, 2013 and claims the benefit of priority under 35 U.S.C. §119 of European Patent Application EP 12199514.6 filed Dec. 27, 2012, the entire contents of which are incorporated herein by reference.

### FIELD OF THE INVENTION

The invention relates to a pump assembly with an electric drive motor arranged in a stator housing and with an electronics housing arranged on the outer side of the stator housing.

### BACKGROUND OF THE INVENTION

Pump assemblies, in particular circulation pump assemblies usually comprise a pump housing, in which at least one pump impeller is arranged, and a motor housing or stator housing, which is connected to the pump housing and in which an electrical drive motor is arranged. As a rule, an electronics housing or terminal box is arranged on the outer side of the stator housing and in which electronic components for the control or regulation of the drive motor are accommodated. These electronic components often comprise components which greatly heat up on operation, for example components of power electronics, such as a frequency converter. The produced heat must be led away to the outside in a suitable manner.

### SUMMARY OF THE INVENTION

It is therefore an object of the invention, to improve such a pump assembly, to the extent that the waste heat arising in the electronics housing can be led away to the outside in an improved manner.

The pump assembly according to the invention, as with known pump assemblies, comprises a motor housing or a stator housing, in which an electrical drive motor is arranged. This electrical drive motor drives at least one pump impeller which can be arranged in a pump housing connected to the stator housing. A terminal box or electronics housing, in which electronic components in particular for the control or regulation of the electrical drive motor are accommodated, is arranged on the outer side of the stator housing. The electronic components can in particular comprise power electronics of a frequency converter for activation or the regulation (closed-loop control) of the electrical drive motor. The electronics housing is delimited by an outer wall. This outer wall comprises at least one opening. Thereby, the opening is situated in a section of the outer wall which does not face the stator housing. At least one heat distributor or cooling body, for leading away heat from at least one electronic component, is arranged in the inside of the electronics housing. Thereby, this heat distributor according to the invention is arranged such that it is situated at the opening in the outer wall of the electronics housing. Thus, it is possible for the heat to be led away to the outside through the opening, without an insulating element such as the outer wall of the electronics housing inhibiting the heat discharge from the heat distributor to the outside. Simultaneously, the arrangement of the heat distributor in the inside of the electronics housing permits a direct and good heat-conducting connection onto the electronic component or components to be cooled. Thus, as a whole, the heat discharge is improved. Due to the fact that the opening is situated in a region of the outer wall of the electronics housing, said region not facing the stator housing, it is ensured that a good air exchange for cooling the heat distributor from the outside is given in this region. Moreover, there is no risk of any additional heating in this region due to the waste heat of the drive motor in the stator housing.

The electronics housing can be situated on a radial side or the axial side of the stator housing with respect to the longitudinal axis or rotation axis of the electrical drive motor which corresponds to the longitudinal axis of the stator housing.

The electronics housing is preferably designed as a component which is independent of the stator housing. Alternatively, however, it is also conceivable for parts of the electronics housing, in particular parts of an outer wall of the electronics housing to be designed integrally with the parts of the stator housing, in particular to be designed in a single-piece manner of plastic.

Particularly preferably, the electronics housing is applied onto the stator housing at the axial side and comprises at least one section which projects in the radial direction beyond the outer periphery of the stator housing, wherein the opening is designed in an outer wall of the electronics housing which is situated on an axial side of the electronics housing which faces the stator housing, in the region of the projecting section. With this design, the region or section of the outer wall, in which outer wall the opening is situated, although being formed on a side of the electric motor which faces the axial side of the stator housing, the section itself however, in which the opening is situated, does not face the stator housing since it is situated on the section projecting radially beyond the stator housing. I.e. the opening at the radial side of the stator housing is situated such that it faces or is directed preferably in the viewed direction parallel to the longitudinal axis of the stator housing. Thus, the opening is situated laterally of the stator housing and air for cooling the heat distributor situated at the opening can easily flow over it. Considered from the axial side of the electronics housing which is away from the stator housing, the opening thereby however lies at the rear side of the electronics housing. This is advantageous if operating elements and display elements are to be arranged on the axial end-face of the electronics housing which is away from the stator housing. Thus, on the one hand adequate space is left for the operating and display elements and on the other hand the heat distributor thus lies in a region which does not need to be contacted for operation, so that the danger of being burnt is reduced for an operating person. Moreover, the heat distributor with regard to the operating side of the pump assembly is placed in an essentially invisible manner.

Preferably, the heat distributor closes the opening, wherein further preferably a seal is arranged between the heat distributor and the outer wall surrounding the opening. Thus, one prevents moisture from being able to penetrate into the inside of the electronics housing, in this region.

The heat distributor is further preferably situated completely in the inside of the electronics housing or it extends through the opening out of the inside of the terminal box, to the outside. If the heat distributor extends outwards through the opening and thus a part of the heat distributor is situated outside the electronics housing, this has the advantage that an even better heat discharge is achieved, since air can flow better over the part situated at the outside. Thus, the waste heat out of the inside of the electronics housing can be led away to the outside in an optimized manner by way of a direct heat-conducting connection via the heat distributor. If the heat distributor is situated completely in the inside of the electronics housing, then air can flow over it only in the region of the window formed by the opening. The complete arrangement in the inside of the electronics housing however has the advantage that no elements of the heat distributor project in a disruptive manner to the outside beyond the outer wall of the electronics housing, which on the one hand improves the optical fashion of the electronics housing and on the other hand reduces the danger of an accidental contact with a hot heat distributor.

The heat distributor is preferably designed as a molded component or as a formed part of sheet metal. Thereby, it is further preferably the case of a molded component of metal, such as aluminum for example which has a high thermal conductivity. Alternatively, the molded component can also be designed of a thermally conductive plastic. If the heat distributor is designed as a formed part of sheet metal, then the sheet metal can preferably be shaped such that it has a plane section which is in heat-conductive connection with the electronic component to be cooled. Moreover, the sheet metal piece can then be corrugated or shaped in a structured manner in the other regions, in order to enlarge the surface for an improved heat discharge.

Particularly preferably, the heat distributor in the region of the opening is essentially exposed to the outer side or is covered by maximally 50% of its base surface or area, which corresponding to the area of the opening. It is thus ensured that an adequate air circulation is given for cooling the heat distributor.

According to a particular embodiment of the invention, a region of the heat distributor in the inside of the electronics housing can be connected in a thermally-conductive manner to at least one electronic component, wherein this region is situated at least partly outside the outer contour of the opening. This has the advantage that the electronic component to be cooled or the electrical component to be cooled, in the inside of the electronics housing, does not need to be arranged directly below the opening. Moreover, this design permits the heat distributor to be structured in the region of the opening such that it comprises a large surface for an improved heat discharge and simultaneously permits the region, in which the contact to the electrical component is created, to be designed in a plane manner. This is particularly advantageous if the heat distributor is designed as a formed part of sheet metal.

According to a further preferred embodiment, the heat distributor is situated on the outer side of the electronics housing, in a manner distanced to the stator housing. Thus, one prevents additional waste heat from the electrical drive motor being transmitted by the stator housing onto the heat distributor. Thus, an optimized cooling of the heat distributor is ensured by way of the surrounding air. Particularly preferably, the heat distributor is arranged radially distanced to the stator housing. This above all is the case if the heat distributor is situated at the axial side of an electronics housing applied axially onto the stator housing, said axial side facing the stator housing, i.e. in a radially projecting section of such an electronics housing as was previously described.

According to a further special embodiment of the invention, the outer wall of the electronics housing, in which the opening is formed, can comprise a step or indentation which projects into the inside of the electronics housing and in which the opening is situated. This has the advantage that the opening can be relocated further into the inside of the electronics housing, so that the opening can be brought into the vicinity of an electronic component which is situated there. Thus, the electronic component can be placed as close as possible to the opening, in order to be able to then lead the occurring waste heat to the outside in an as direct as possible manner,

Moreover, the step or the indentation on the outer side of the electronics housing can form a space, in which at least a part of the heat distributor extending outwards through the opening, is situated. Thus, the step preferably on the outer side of the electronics housing forms a first indentation, in which the heat distributor is situated. This design has the advantage that the heat distributor can be arranged and designed such that although a part of the heat distributor is situated outside the interior of the electronics housing, the heat distributor does not essentially project beyond the complete outer contour of the electronics housing, so that the aesthetics of the electronics housing are improved. Moreover, projecting components which could become easily damaged on assembly are thus avoided. Preferably, the part of the heat distributor which is situated outside the electronics housing is thus situated completely within the indentation formed by the step.

Particularly preferably, the heat distributor is situated completely within the axial extension of a peripheral wall of the electronics housing. This outer peripheral wall can also extend around the indentation, so that the heat distributor does not extend beyond the peripheral wall. With the previously described preferred design, with which the heat distributor is situated in a radially projecting section of an electronics housing arranged at the axial side on the stator housing, one can thus succeed in the heat distributor, although extending outwards through the opening in the terminal box, not extending in the axial direction beyond the axial extension of the peripheral wall. The peripheral wall is thereby that wall of the electronics housing which extends transversely to the axial sides of the terminal box, i.e. extends about the longitudinal axis of the stator housing and of the electronics housing, preferably parallel to this axis. The peripheral wall thereby defines the overall outer contour of the electronics housing.

According to a further preferred embodiment, the heat distributor in the inside of the electronics housing bears in a thermally conductive manner on at least one electronic component which is arranged on a circuit board, wherein the circuit board extends essentially parallel to the outer wall of the terminal box, in which the opening is formed. Preferably, it is thereby the case of an axial-side outer wall of the electronics housing which is adjacent the axial side of the stator housing. Preferably, the outer wall in which the opening is formed, is a base of the electronics housing which faces the stator housing, wherein the opening is situated in a part of the base which projects laterally or radially beyond the stator housing, so that the opening does not face the stator housing.

Further preferably, a receiving space is present in the inside of the electronics housing, laterally of the previously described step projecting into the inside of the electronics housing, in which receiving space the outer wall of the electronics housing in the axial direction is distanced further to a circuit board situated in the electronics housing than in the region of the step and in which at least one electronic component with a large construction height is arranged. It is thereby preferably the case of an outer wall which extends parallel to the circuit board in a manner distanced to this and in which the described opening is arranged. By way of this stepped design of the outer wall, on the one hand one succeeds in an indentation or a free space for receiving the heat distributor being created on the outer side of the electronics housing and on the other hand in the circuit board in the interior being able to be arranged as close as possible to the opening, but in retaining the possibility of arranging components of a greater construction height, such as a capacitor, on the circuit board. These are then situated in the receiving space which is situated laterally of the opening and in which the electronics housing provides a greater height and a greater free space by way of the circuit board.

The receiving space is further preferably situated between the step and a peripheral wall of the electronics housing, preferably on a side of the step which is away from the rotation axis or longitudinal axis of the drive motor. This is particularly the case if the opening with the heat distributor is arranged in an electronics housing which is applied onto the stator housing at the axial side. Then the receiving space can be situated in a radially projecting section of the electronics housing in the region distanced furthest to the longitudinal axis or rotation axis of the stator housing. The opening with the heat distributor, seen in the radial direction, then lies between the receiving space and the outer wall of the stator housing. This design has the advantage that the region of the electronics housing which is situated on the axial side above the stator remains free for the connections, in particular also the electrical connections between the electronics housing and the stator housing.

According to a further preferred embodiment, with the pump assembly according to the invention, a connection element is provided, which comprises a first plug connector connected to a corresponding plug contact or a corresponding plug coupling on a circuit board arranged in the inside of the electronics housing, and a second plug connector provided for the connection of an electrical connection lead, wherein the connection element is preferably arranged on an outer side of the electronics housing and with its first plug connector engages through an opening into an outer wall of the electronics housing into the inside of this housing. This connection element thus creates the electric connection of the pump assembly between an electrical connection lead, in particular a mains connection lead, and the electronic components on the circuit board. According to this embodiment, thus no connection plug is to be attached directly on the circuit board, but rather the intermediately connected electrical connection element is provided. The additional electrical connection element provides several advantages. Thus, on the one hand a simple adaptation to different connection standards can be created with this connection element, since for example the second plug connector on the connection element can be designed differently given different connection elements, whilst the first plug connector is always designed the same. The connection element then therefore serves as a type of adapter. Moreover, on account of the connection element, one prevents a connection lead having to be connected directly to the circuit board or connection elements arranged there. Thus, a damaging of the circuit board is prevented on connection. Moreover, due to the connection element, the second plug contact can be very simply brought into a position which is well accessible from the outside, without the circuit board having to be placed in the inside of the electronics housing in an optimized manner for the electrical connection. Thus, more freedom results for the arrangement of the circuit board in the electronics housing. With the arrangement of the connection element on the outer side of the electronics housing, there exists the further advantage that a connection lead or a connection plug does not need to be introduced into the inside of the electronics housing at all, so that an improved sealing of the electronics housing can be achieved in the region of the electrical connection. Finally, the additional connection element forms an inexpensive alternative to electrical strip conductors which are molded into the wall of the electronics housing. Thus, one can make do without such strip conductors, but a simple contacting of the circuit board can be realized despite this, solely by way of plug connections.

The described connection element is preferably manufactured as a shaped part of plastic and thereby is designed in an intrinsically stable and shape-stable manner. Thus, the connection element in contrast to a cable always assumes a defined shape and position, by which means the secure assembly is favored. Preferably, strip conductors molded into the plastic material of the connection element are present in the inside of the connection element and connect the first and the second plug connector of the connection element to one another.

Further preferably, an outer wall of the electronics housing comprises an inwardly directed second indentation, in which the connection element is arranged, wherein the indentation is preferably situated at a corner of the electronics housing. Thus, the indentation and the connection element can be designed such that the connection element merges into the remaining outer contour of the electronics housing when it is situated in the indentation and preferably does not project outwards beyond the outer contour defined by the electronics housing. Thus, a harmonic total impression is ensured. The arrangement of the indentation at the corner of the electronics housing has the advantage that the connection element at the corner can be placed in a well accessible manner, so that the second plug connector, on which the connection lead is connected, is well accessible. With the embodiment, with which an electronics housing is arranged on the stator housing at the axial side and comprises a section projecting radially beyond the stator housing, the indentation is preferably situated in this radially projecting section, so that the connection element is likewise situated in a well accessible manner in the projecting region laterally of the stator housing.

According to a further preferred embodiment, the heat distributor is electrically conductively connected to an earth contact to a circuit board situated in the inside of the electronics housing or to an earth conductor formed on this circuit board, wherein this connection in particular can be created via a screw. Thereby, at least one earth conductor which is connected preferably via a suitable plug contact to the previously described connection element and via this to the earth conductor of a connection lead, is formed on the circuit board. The earth connection of the heat distributor via the circuit board has the advantage that one can make do without an additional earth conductor in the inside of the electronics housing, so that the assembly is simplified. The circuit board extends in any case into the proximity of the heat distributor, since this is in heat-conductive connection with at least one electronic component on the circuit board.

With the previously described pump assembly according to the invention it is preferably the case of a circulation pump assembly, for example a heating circulation pump assembly or a circulation pump assembly for an air-conditioning installation or for circulating service water. The electrical drive motor is preferably designed as a wet-running drive motor, i.e. as a canned motor.

The invention is hereinafter described by way of example and by way of the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a lateral view of a pump assembly according to the invention;

FIG. 2 is a lateral view of the pump assembly according to FIG. 1, which is rotated by 90°;

FIG. 3 is a plan view of the pump assembly according to FIGS. 1 and 2;

FIG. 4 is a partly exploded representation of the electronics housing of the pump assembly according to FIGS. 1-3;

FIG. 5 is a perspective view of the electronics housing according to FIG. 4, in the opened condition;

FIG. 6 is an enlarged detail view of detail VI of FIG. 5;

FIG. 7 is an enlarged detail view of detail VII of FIG. 5;

FIG. 8 is a side view of the opened electronics housing according to FIGS. 4-7, with a removed circuit board;

FIG. 9 is an exploded representation of the electronics housing according to FIG. 8;

FIG. 10 an exploded representation of the electronics housing according to FIG. 5;

FIG. 11 is a lower side view of the electronics housing according to FIGS. 4-10;

FIG. 12 is a sectioned view of the pump assembly according to FIGS. 1-3;

FIG. 13 is an exploded view of the pump assembly according to FIG. 12;

FIG. 14 is a partly exploded representation of an electronics unit of a pump assembly according to a second embodiment of the invention;

FIG. 15 is a perspective view showing the electronics unit according to FIG. 14 in a joined condition;

FIG. 16 is a partially exploded representation showing the electronics unit according to FIGS. 14 and 15;

FIG. 17 is a perspective representation showing the cover of the electronics housing according to FIG. 15;

FIG. 18 is a sectioned view of the cover according to FIG. 16;

FIG. 19 is an enlarged detail view showing the detail XIX of FIG. 17; and

FIG. 20 is a perspective view showing the arrangement of the electronics housing of the embodiment according to FIG. 13-19, on a stator housing.

### DESCRIPTION OF THE PREFERRED EMBODIMENTS

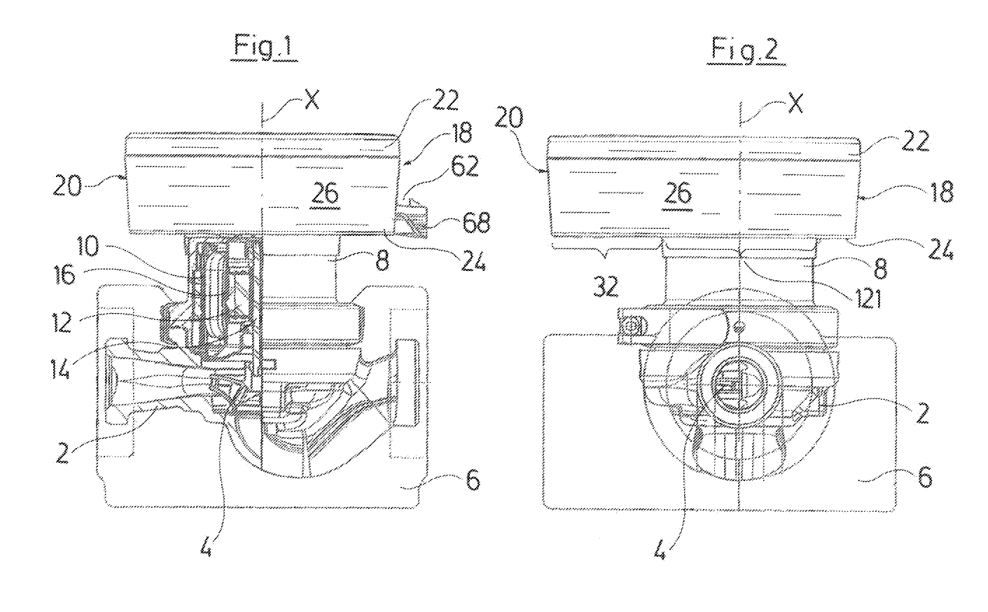

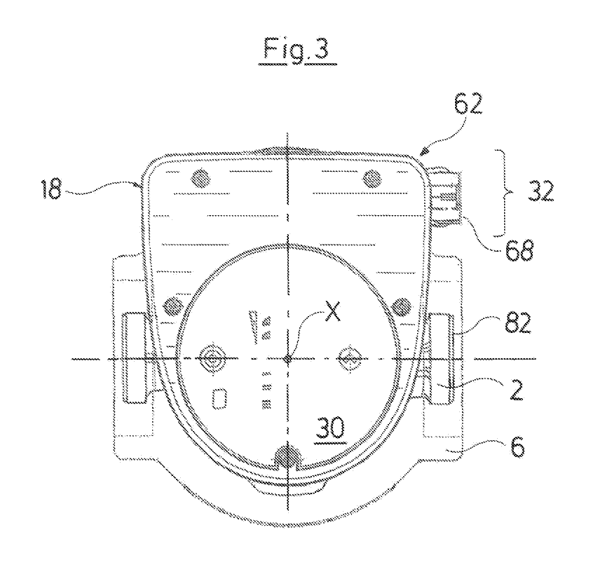

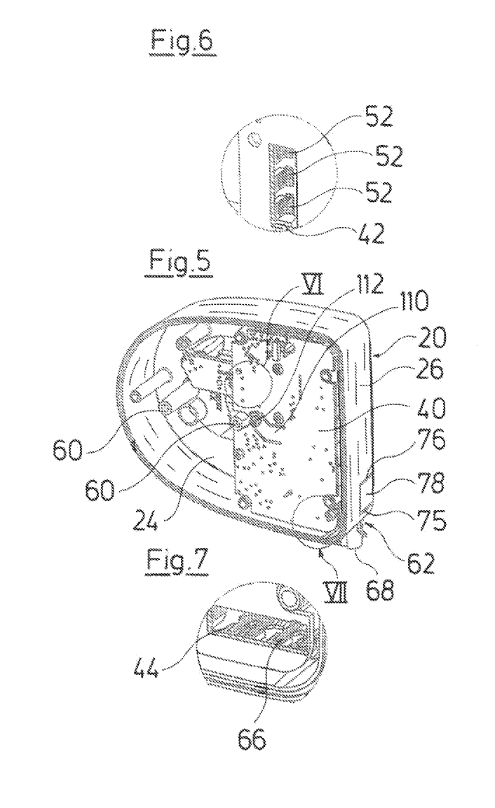

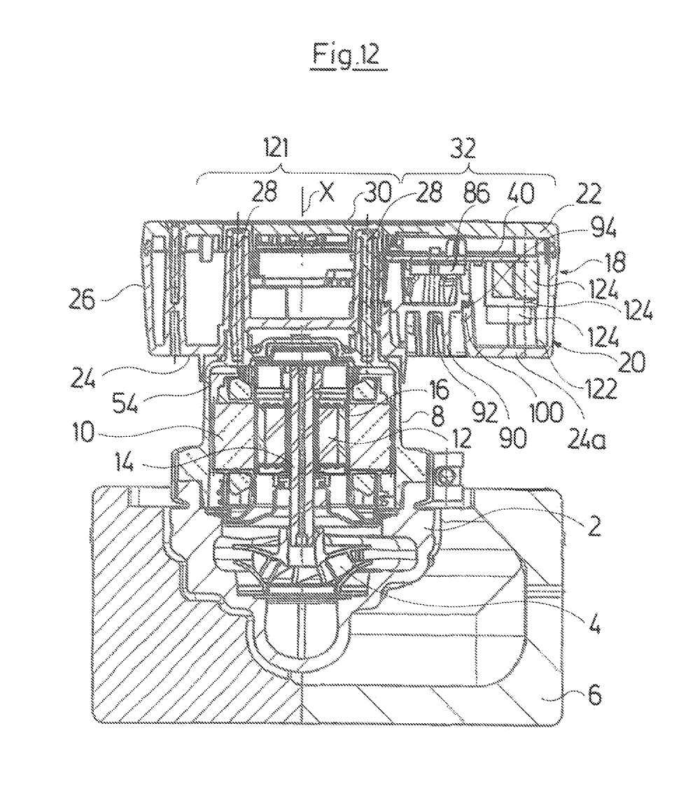

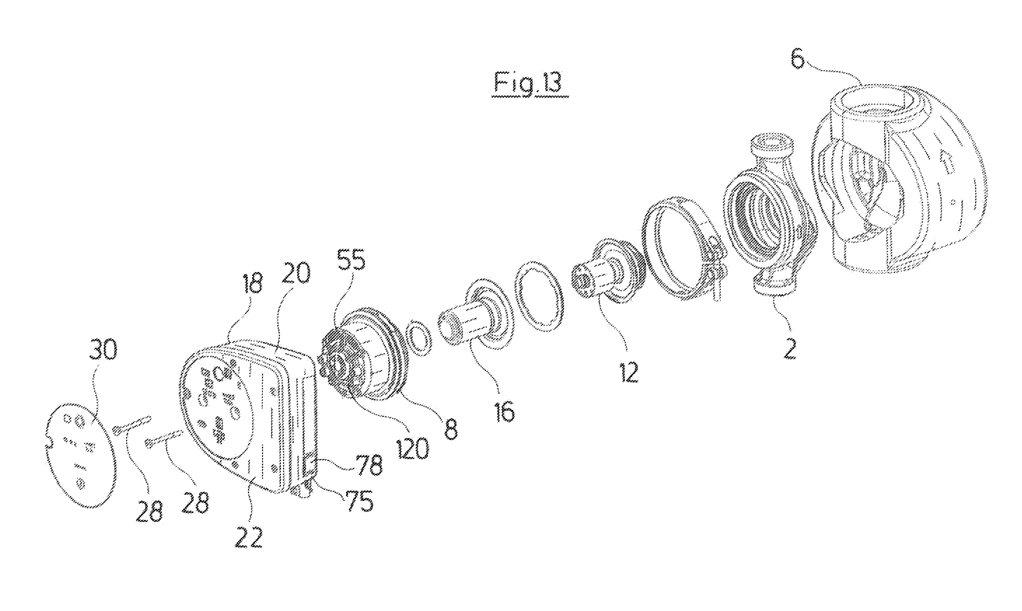

A first embodiment of the invention is described by way of FIGS. 1-13. Thereby, the FIGS. 1-3, 12 and 13 show the pump assembly according to this preferred embodiment, in an entire view. The pump assembly in the known manner comprises a pump housing 2, in which an impeller 4 is arranged. The pump assembly is thus designed as a centrifugal pump assembly. In the example shown here, the pump housing 2 is surrounded by an insulation element 6. The pump housing 2 is connected to a motor housing or stator housing 8 which connects onto the pump housing 2 in the axial direction in the direction of the longitudinal or rotation axis X. The electric drive motor which in particular comprises a stator 10 and a rotor 12 rotatable in this is arranged in the stator housing 8. The rotor 12 is preferably designed as a permanent-magnetic rotor. The rotor 12 is connected to the impeller 4 in a rotationally fixed manner via the rotor shaft 14. The electrical drive motor is designed as a wet-running electrical drive motor, i.e. it comprises a can 16.

A terminal box or an electronics housing 18 is applied onto the stator housing 8 at the axial end of the stator housing 8 (seen in the direction of the longitudinal axis) which is away from the pump housing 2. The electronics housing 18 is designed as a molded part of plastic, wherein it is designed in a two-part manner and comprises a lower part 20 and a cover 22 applied onto the lower part 20. The lower part 20 is designed in an essentially pot-like manner and comprises a base 24 which faces the stator housing 8. Departing from the base 24, an outer wall 26 extends on the outer periphery of this base, in the axial direction in the direction away from the stator housing 8. Thereby, the outer wall 26 extends essentially in the direction of the longitudinal axis X. The cover 22 for the closure of the electronics housing is applied on the open end of the outer wall 26 which is distanced to the base 24. The base 24 of the electronics housing is screwed to the stator housing 8 via two screws 28. An operating panel 30 with operating and display elements is formed on the outer side of the cover 22.

The electronics housing 18 transversely to the longitudinal axis X has a greater extension than the radial extension of the stator housing 8. Thus, the electronics housing 18 has a section 32 which projects radially or laterally beyond the outer periphery of the stator housing 8. The electronics housing 18 however also slightly projects in the radial direction concentrically to the longitudinal axis X, beyond the outer periphery of the stator housing 8, also in other directions. However, it projects further to one side in the form of the projecting section 32. This region is also widened in the tangential direction in a manner departing from the region at the axial end of the stator housing 8.

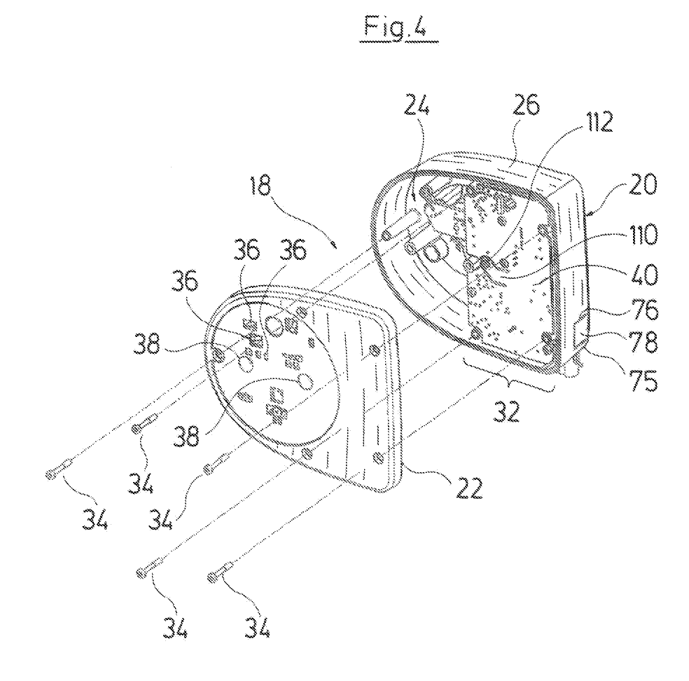

The construction of the electronics housing 18 is hereinafter explained in more detail. The cover 22, as shown in FIG. 4, is screwed to the lower part 20 by way of screws 34. In the representation in FIG. 4, the film forming the operating panel 30 is removed from the cover. One can merely recognize openings 36 in the cover 22, which permit the access to the operating elements and display elements arranged on the lower side of the cover which faces the lower part 2. These openings 36 are covered by the film of the operating panel 30 and are closed. Thereby, the film of the operating panel 30 also covers the holes 38, through which the screws 28 for fastening the lower part 20 on the stator housing 8 are led.

A circuit board 40 as an essential element is arranged in the inside of the electronics housing 18, i.e. in the interior which is spanned by the peripheral or outer wall 26 and the base 24 and which is closed by the cover 22. In the known manner, strip conductors are formed on the circuit board 40 and electrical and electronics components for the control or regulation of the drive motor are attached in the stator housing 8. In particular, a frequency converter can be formed on the circuit board.

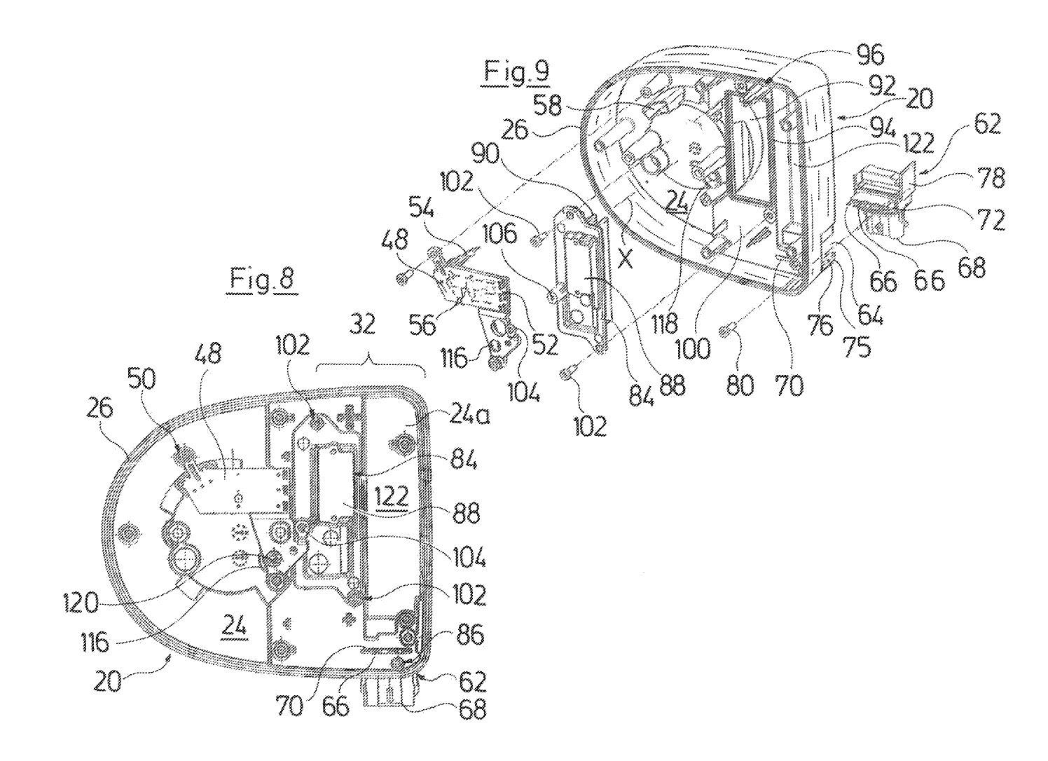

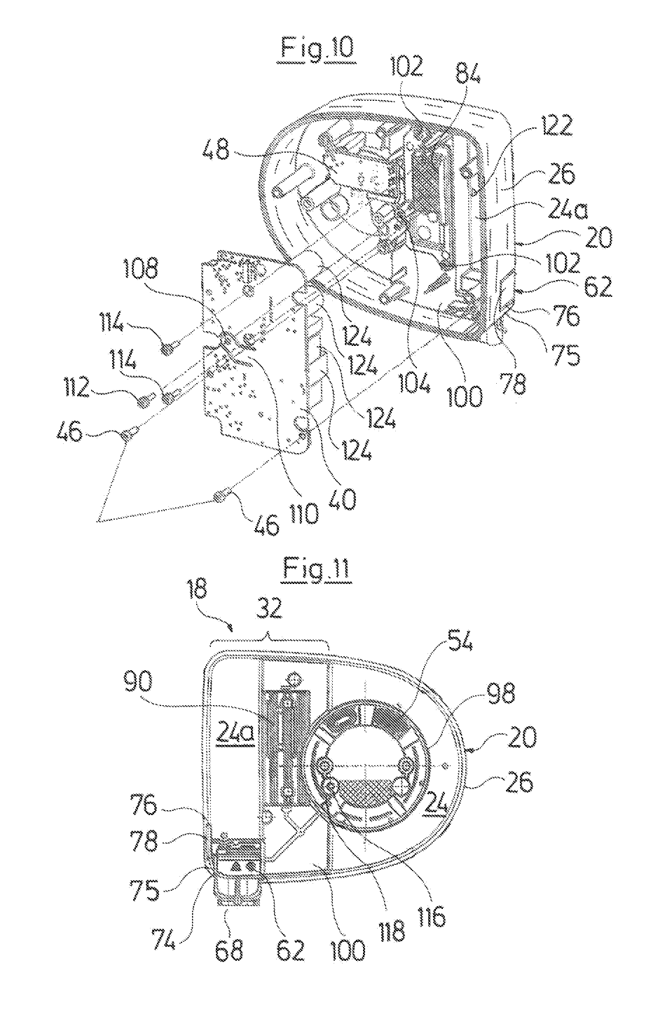

Two plug couplings, a first plug coupling and a second plug coupling 44 are formed on the circuit board 40. The first and the second plug coupling 42 and 44 serve for the connection to connection elements for connection to external components, as is explained in more detail by way of FIGS. 8 and 9. In the representation according to FIGS. 8 and 9, as is shown in FIG. 10, the circuit board 40 is removed from the electronics housing 18. The circuit board 40 is fastened with screws 46, in the lower part 20 of the electronics housing 18. A first connection element which forms a stator connection element 48 serves for the electrical connection of the stator 10 to the electronic and electrical components on the circuit board 40. I.e. the stator 10 here forms the external component. The stator connection element 48 is designed as a separate component which by way of a screw 50 and one of the screws 46 fixing the circuit board 40 in the lower part 20, is screwed on the lower part 20 of the electronics housing 8. The lower part 20 is designed as a purely plastic housing and has no fixedly arranged conductors or strip conductors in its inside, in particular no strip conductors molded into the plastic material. Such are replaced by strip conductors which are formed in the stator connection element 48. The stator connection element 48 is designed as an intrinsically stable shaped part of plastic and comprises a first plug connector 52 and a second plug connector 54. The stator connection element 48 has a flat middle region which extends parallel to the base 24 and the circuit board 40 in the inside of the electronics housing 18. At opposite ends of this middle region, i.e. in a direction transverse to the longitudinal axis X, the first plug connector 52 and the second plug connector 54 are arranged distanced to one another. Moreover, the first plug connector 52 and the second plug connector 54 are directed in the direction of the longitudinal axis X in opposite directions. I.e. the plug directions, in which the plug connectors 52 and 54 are contacted, are aligned essentially parallel but opposite to one another. In the example shown here, the plug connectors 52 and 54 are designed in a three-pole manner and are connected to one another in the inside of the stator connection element 48 via strip conductors 56 which are represented dashed in FIG. 9. The strip conductors 56 are molded into the plastic material so that this simultaneously electrically insulates the strip conductors 56. The second plug connector 54 extends through an opening 58 in the base 24 of the lower part 20 of the terminal box 18 out of the interior of the electronics housing 18 and engages through an opening 55 an the axial side, into the inside of the stator housing and there comes into contact with connection contacts or a connection plug, for contacting the coils in the stator 10. The first plug contact 52 electrically conductively engages with the first plug coupling 42 on the circuit board 40.

As is to be recognized, due to stator connection element 48, it is possible for the circuit board 40 not to have to be situated above the opening 58, but it can be arranged laterally shifted to this in the direction transverse to the longitudinal axis X, in the electronics housing 18. This has the advantage that the region, through which the screws 28 extend through the guides 60 in the lower part 20 in the electronics housing 18, remains free, so that the fastening of the electronics housing 18 on the stator housing 8 is not inhibited by the circuit board 40 in the inside. In contrast to molded-in conductors in the electronics housing, the stator connection element 48 has the advantage that the manufacturing procedure for manufacturing the lower part 20 is simplified, since no strip conductors need to be molded in. Compared to a cable connection, the stator connection element 48 has the advantage that it is shape-stable and thus is positioned in the lower part 20 in a defined manner, so that an unintended clamping and damage of cables cannot occur.

The second plug coupling 44 of the circuit board 40 is connected to the second connection element which is formed on the mains connection element 62. The mains connection element serves for the connection of an external component in the form of a mains connection lead. Whilst the stator connection element 48 is arranged in the inside of the electronics housing 18 and only extends with its second plug connector 54 to the outside out of the electronics housing 18, the mains connection element 62 is arranged on the outside of the electronics housing 18 or its lower part 20. The mains connection element 62 is arranged in an indentation 64 which is formed in the base 24 of the lower part 20. The indentation 64 is directed into the inside of the lower part 20, i.e. in the region of the indentation 64, the base 24 is situated closer to the cover 22 in the axial direction X than the base 24 directly above the stator 8. The indentation 64 thus on the outer side of the lower part 20 creates a receiving space, in which the mains connection element 62 is received such that it does not project beyond the overall outer contour of the electronics housing 18 which is defined by the peripheral or outer wall 26. In particular, the mains connection element 62 does not project in the axial direction X beyond this outer contour.

The mains connection element 62 is designed as a shaped part of plastic with electrical strip conductors which are molded into the plastic material. The electric strip conductors form a first plug connector 66 which comes into electrically conductive engagement with the second plug coupling 44 on the circuit board 40. In this example, the first plug connector 66 and the second plug coupling 44 are designed in a three-poled manner. Thus, two mains conductors and one earth conductor are present. A second plug connector 68 which as a plug coupling is designed for the connection of a mains connection lead which is not shown here, is connected to the first plug connector 66 via the strip conductors in the inside of the mains connection element 62. The first plug connector 66 extends through an opening 70 in the base 24 of the lower part 20 into the inside of the lower part 20 and thus of the electronics housing 18, in order to engage there with the second plug coupling 44 of the circuit board 40. A seal 72 which comes to sealingly bear on the outer side of the base 24 and thus seals the opening 70 to the outside is arranged on the mains connection element 62 in a manner surrounding the first plug connector 66. Alternatively, this seal 72 could also be formed on the base 24 of the lower part 20.

The second plug connector 68 is designed angled by 90° with respect to the first plug contact 66, so that the second plug connector 68 extends towards the peripheral wall 26 or laterally outwards through an opening or recess 74. I.e., the plug directions of the first plug connector 66 and of the second plug connector 68 are directed at an angle of 90° to one another. The recess 74 is situated in a wall 75 which surrounds the indentation 64. This wall 75 represents an axial extension of the outer wall 26 and thus forms a part of the outer wall 26, even if it does not surround the interior of the lower part 20 or of the electronics housing 18. A second recess 76 is formed on an adjacent side surface of the indentation 64, in this wall 75. The indentation 64 is situated at a corner of the lower part 20, so that the recesses 74 and 76 are situated on two walls or wall sections, which are extend essentially at an angle of 90° to one another. If the mains connection part 62 is situated in the indentation 64, an outer surface 78 lies in the recess 76 and closes this, so that the outer surface 78 of the mains connection element 62 merges into the wall 75 or the outer side of the peripheral wall 26 in a harmonic or flush manner. The mains connection element 62 is preferably designed as one piece of plastic. Thereby, the plastic preferably has a color which differs from the color of the surrounding outer wall 26 and thus of the complete lower part 20. This can be advantageous, in order to attach a visible inscription, for example a QR code, which would be poorly readable on the color of the outer wall 26, on the outer surface 78. Thus, one can make do without an inscription panel which is to be additionally attached. This in contrast is provided by the outer surface 78.

The mains connection part 62 is fixed in the indentation 64 by way of a screw 80 which extends from the inside through the base 24 of the lower part 30. I.e. the mains connection element 62 cannot be released from the outer side. Thus, one ensures that the electronics housing 18 remains securely closed in this region. Due to the fact that the mains connection element 62 is arranged in the indentation 64 situated in the projecting section 32 at a corner, the second plug connector 68 extending to the side is well accessible for the connection of the mains connection lead 62. Thereby, the second plug connector 68 is directed parallel to a suction nozzle 82 extending downwards, given a preferred installation position of the pump assembly.

The use of the mains connection element has the advantage that a mains connection lead does not need to be connected directly to the circuit board 40 or to the electrical conductors which are arranged there. Thus, for the connection of the mains connection lead, it is not necessary to open the electronics housing 18, by which means an unintended damage to electrical or electronic components in the inside can be prevented on connection of a mains connection lead. The arrangement of the mains connection element 62 on the outside moreover has the advantage that the opening 70 in the base 24 can be well sealed from the outside, so that a penetration of moisture can be prevented in this region. Moreover, the mains connection element 62 could assume an adapter function, with which different second plug connectors 68 are provided, in order to be able to connect differently shaped counter-pieces of mains connection leads here. Thus, an adaptation of the electronics housing 18 to different connection leads can be realized, without having to change the essential components such as the circuit board 40. Moreover, one can make do without strip conductors arranged in the lower part 20 and thus the electronics housing 18, also in the region of the mains connection.

Furthermore, a heat distributor 84 is arranged in the lower part 20 and serves for the cooling of heat-producing electronic components on the circuit board 40. Such an electronic component 86 can for example be the power switch of a frequency converter. With the arrangement selected here, the electronic component 86 to be cooled is situated on the side of the circuit board 40 which faces the base 24. The component 86 to be cooled bears on the contact surface 88 on the heat distributor 84 in a thermally conductive manner. The contact surface 88 extends essentially parallel to the base 24 and to the circuit board 84, i.e. normally to the longitudinal axis or rotational axis X. The heat distributor 84 is designed as a cast component of metal, for example aluminum and on its axial side which is away from the contact surface 88 comprises a rib structure 90. The heat distributor 84 is arranged in the inside of the electronics housing 18 or its lower part 20, such that it extends outwards through a recess or opening 92 in the base 24 of the electronics housing 18, in a manner such that the rib structure 90 is situated on the outer side of the lower part 20, whilst the contact surface 88 is situated in the inside. A seal 94 is arranged on the peripheral region of the opening 92 and comes to sealingly bear on the corresponding contact surface on the heat distributor 84, so that the heat distributor 84 sealingly closes the opening 92. The seal 94 is usefully molded directly onto the lower part 20 with two-component injection molding. Thus, the seal 94 can be molded simultaneously with further seals 96 and 98, which serve for sealing the cover 22 as well as the base 24, with respect to the axial end of the stator housing 8.

The base 24 of the lower part 20 comprises a step 100 in the region of the opening 92. The step 100 projects into the inside of the electronics housing 18. Thus, the step 100 forms an inwardly directed indentation and has the effect that the opening 92 is situated closer to the circuit board 40 in the axial direction, than the remaining region of the base 24. Thus, the opening 92 and thus the contact surface 88 of the heat distributor 64 inserted into the opening can be brought into the proximity of the circuit board 40, in order there to be brought directly into contact with the electronic component 86 to be cooled. Simultaneously, an indentation or a receiving space is created on the outside of the opening 92, i.e. on the outer side or lower side of the lower part 20 which faces the stator housing 8, in the region of the step 100, wherein the outer part of the heat distributor, specifically the rib structure 90 has space in this indentation or receiving space. Thus, one succeeds in the rib structure 90 although lying outside the electronics housing 18, however lying within the outer contour of the electronics housing which is defined by the outer wall 26. In particular, the rib structure 90 in the axial direction does not project beyond the base 24 of the electronics housing 18 which is adjacent the stator housing 8. The rib structure 90 thereby lies further laterally or to the radial side, of the outer periphery of the stator housing 8 in the projecting section 32, so that air can freely flow over it at the lower side of the electronics housing 18 which faces the stator housing 8. The opening 92, through which the heat distributor 84 extends outwards with its rib structure 90, thus lies in a region which does not face the stator housing. Although the base 24 basically faces the axial end of the stator housing 8, the base however in the projecting section 32 does not face the stator housing 8, but faces a region at the radial side of the stator housing, i.e. outside the stator housing. Thus, the opening 92 with the heat distributor 84 lies in a region of the electronics housing 18 which is away from the stator housing 8. The cooling of the rib structure 90 via the surrounding air is further encouraged due to the fact that the rib structure 90 is not covered by housing parts. Simultaneously, the upper side of the electronics housing 18, i.e. of the cover 22, on which the operating panel 30 is situated, is kept free of components leading away heat. Thus, the heat distributor 84 is essentially not visible from the operating side, so that it does not upset the optical impression of the electronics housing 18.

The heat distributor 84 is fastened in the lower part 20 via two screws 102. Moreover, the heat distributor 88 is connected to an earth terminal of an earth connection in the stator connection element 48. The earth connection in the stator connection element 48 is likewise designed as a molded-in strip conductor 56 which ends at an eyelet-like or annular earth terminal 104. The annular earth terminal 104 comes to lie in the heat distributor 84 via a threaded hole 106, when assembling the stator connection element 48. An earth contact 108 of the circuit board 40 comes to lie above the annular earth terminal 104, away from the threaded hole 106. The earth contact is formed by a strip conductor surrounding a hole and is situated on a tongue-like section 110. The tongue-like section 110 is formed in the circuit board by way of cuts. A screw 112 extends through the hole of the earth contact 108 on the tongue-like section 110 and through the earth terminal 104, into the threaded hole 106. Thus, an earth connection is created between an earth lead formed on the circuit board 40 simultaneously with the earth terminal 104 of the stator connection element 48, and the heat distributor 84. The earth conductor formed on the circuit board 40 is connected via the plug coupling 44 to a corresponding earth contact of the plug connector 66 of the mains connection element 62 and via this to the earth conductor of a mains connection lead.

The arrangement of the earth contact 108 on the tongue-like section 110 has the advantage that with this, the earth contact 108 can be moved together with the tongue-like section 110 with respect to the remaining parts of the circuit board 40. Thus, one prevents stresses being introduced into the circuit board 40 due to the connection of the earth contact 108 to the heat distributor 84 and the stator connection element 48, wherein these stresses can lead to a tearing of strip conductors on the circuit board 40.

Moreover, with this design, the contact between the heat distributor 84 and the earth terminal 104 on the stator connection element 48 is dimensioned such that a heat-conducting connection as is also created apart from an electrically conductive connection. For this, the contact surface between the heat distributor 84 and the earth terminal 104 can be designed larger than is necessary for the electric contact. On account of this, one succeeds in the heat distributor being able to heat the earth terminal 104 and the strip conductor connecting thereto, in the inside of the stator connection element 48. This has the advantage that the strip conductor and the earth terminal 104 in the inside of the electronics housing 18 cannot cool down via a contact with the stator housing 8, as is described hereinafter, which could lead to a condensation of moisture in the electronics housing 18. Such a cooling for example would be feared if the pump assembly were to be applied as a cold water pump, with which a cooling of the stator housing 8 occurs.

Moreover, the electronic component 86 is fixed on the contact surface 88 of the heat distributor 84 via two screws 114.

The stator connection element 48 at its earth connection moreover comprises a further earth terminal 116. This comes to lie above an opening 118 in the base 24 of the lower part 20. A pin 120 which is arranged at the axial end of the stator housing 8 can extend through the opening 118, into the inside of the electronics housing 18 and engage into the earth terminal 116. The pin 120 at the axial side of the stator housing 8 is electrically conductively connected to this and projects in the axial direction X. Spring plates or spring tongues are formed in the earth terminal 116 and come into electrically conductive and cutting engagement with the outer periphery of the pin 120. Thus, an earth connection is created between the metallic stator housing 8 and the earth connection in the stator connection element 48. The earthing then via the stator connection element 48 and its second earth terminal 104, is then effected via the earth conductor on the circuit board 40 and as described, the mains connection element 62.

The described step 100 in the base 24 of the lower part 20 is situated in the projecting section 32 in a manner adjacent to the middle region 121 of the lower part 20 which is applied onto the axial end of the stator housing 8 and is designed in a strip-like manner in the tangential direction. I.e. a region 24a of the base 24 is formed on the radially outer section and projects via the step 100 again in the axial direction to the stator housing 8 and is situated on the same axial level as the remaining region of the base 24 outside the step 10. Thus, a receiving space 122 which has a greater axial height is created in the interior of the lower part 20 in a manner adjacent the step 100. I.e. the axial height between the circuit board 40 and the base 24, 24a, in the region of the receiving space 122 is greater than between the circuit board 40 and the step 100 in the inside of the electronics housing 18. Thus, those electronic components 124 which have a greater axial construction height can project into the receiving space 122. Thus, on account of the design of the step 100 in the base 24 if the electronics housing 18 with the receiving space 122 situated laterally of the step, on the one hand one can succeed in the heat-dissipating electrical component 86 which is to be cooled being able to be arranged in the axial direction in the proximity of the opening 92, through which the heat distributor 84 projects outwards, but simultaneously a greater axial free space for receiving higher electronic components 124 being given laterally but above the circuit board 40, in the receiving space 22. This permits all electronic components to be arranged on a plane circuit board 40 and moreover to design a flat electronics housing 18 which is essentially disk-like in its overall contour and beyond which no components such as a heat distributor 84 project in the axial direction. The indentation 64, in which the mains connection element 62 is situated, as is the case with the receiving space 122, is situated at the side of the step 100 which is away from the longitude axis X. The indentation 64 is thereby connected to the free space which is formed by the step 100 on the outer side of the base 24 and in which the rib structure 90 is situated.

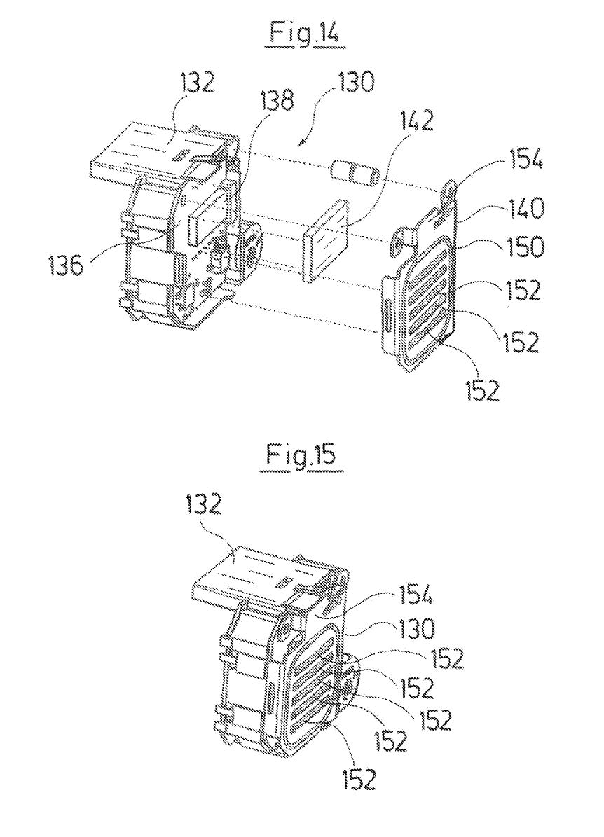

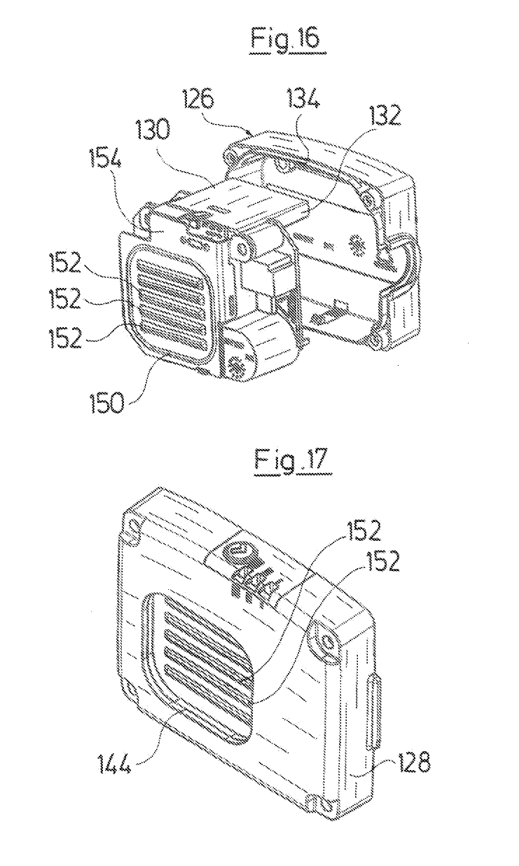

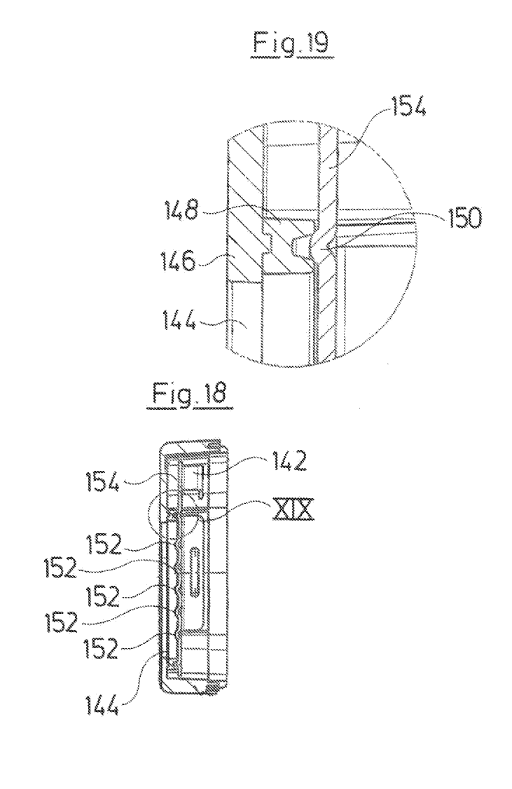

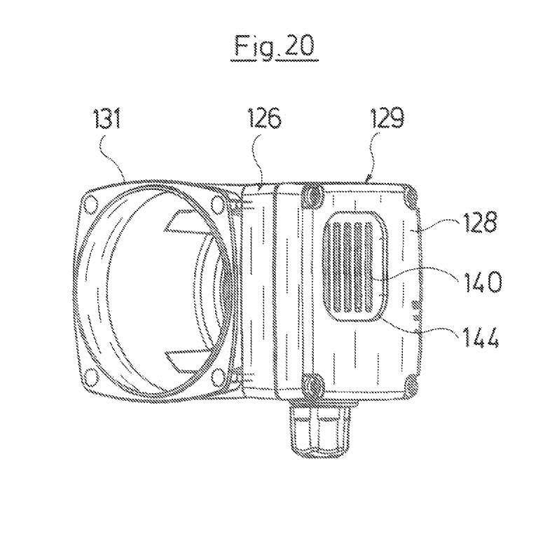

A further possible arrangement according to the invention, of a heat distributor in an electronics housing of a pump assembly is described by way of FIGS. 14-20. The electronics housing shown here consists of a lower part 126 and of a cover 128 which are screwed to one another. The thus formed electronics housing 129 is designed for application onto a stator housing 131, wherein the electronics housing 129 is applied onto the stator housing 131 on the peripheral side, i.e. on the radial side. Accordingly, the electronics housing could however also be applied onto a stator housing on the axial side, as previously described. The lower part 126 of the shown electronics housing 129 is connected to the stator housing 131. An electronics unit 130 is arranged in the inside of the electronics housing 129 formed from the lower part 126 and the cover 128 and comprises electronics components for the control or regulation of an electric drive motor of the pump assembly, for example a frequency converter. The electronics unit 130 comprises a connection plug 132 which extends outwards through an opening 134 in the base of the lower part 26 out of the electronics housing and is envisaged for contacting with a corresponding counter-connection-plug in the stator housing.

The electronics unit comprises a circuit board 136, on which at least one heat-producing component 138, for example the power switch of a frequency converter is arranged. Moreover, a heat distributor 140 is arranged in the inside of the electronics housing. The heat distributor 140 is designed as a formed part of sheet metal and is in thermally conductive connection with the heat-producing electronic component 138 via a thermally conductive cushion 142. It is to be understood that another thermally conductive connection can be created between the heat distributor 140 and the electronic component 138 instead of the thermally conductive cushion 142, for example via a thermally conductive paste or also by way of direct contact.

The heat distributor 140 is situated in the inside of the electronics housing 129, i.e. below the cover 128. The cover 128 comprises an opening 144. The heat distributor 140 is situated in the inside of the electronics housing 129 below the opening 144, so that it closes the opening 144. For this, a seal 148, on which the heat distributor 140 comes to sealingly bear with a projection 150 is arranged between the heat distributor 140 and the wall 146 surrounding the opening 144. Thus, the heat distributor 140 sealingly closes the opening 144 to the outside. The opening 144 is situated in the cover 128 which is away from the stator housing 131, since the lower part 126 is provided for connection to the stator housing 131. Thus, with this arrangement, the heat distributor 140 is arranged in the opening 144 in a region of the electronics housing 129 which is away from the stator housing.

Corrugations 152 are formed in the part of the heat distributor 140 which is situated in the opening 144. The projection 150 and the corrugations 152 are formed by way of embossing the sheet metal component, from which the heat distributor 140 is manufactured, and is directed projecting outwards to the opening 144. The corrugations 152 enlarge the surface of the heat distributor 140 in the region of the opening 144 and thus improve the leading away of heat in this region. The heat distributor 140 in the region of the opening 144 to the outside is not covered by further components and does not project outwards in the axial direction beyond the outer side or front side of the cover 128, i.e. beyond the outer peripheral edge of the opening 144.

The electronic component 138 bears on the heat distributor 140 in a region 154 which is designed in a plane manner and is situated outside the opening 144, i.e. laterally of the opening 144 in the direction of the surface of the cover 128. This has the advantage that the region 154 can be designed in a plane manner without corrugations 152, so that a good thermal transition from the electronic component 138 via the thermally conductive cushion 142 onto the region 154 of the heat distributor 140 can be achieved. Simultaneously, the part of the heat distributor 140 which is situated in the opening 144 and over which air flows can be designed in a structured manner on account of the corrugations 152, in order to achieve a greater surface for an improved cooling.

While specific embodiments of the invention have been shown and described in detail to illustrate the application of the principles of the invention, it will be understood that the invention may be embodied otherwise without departing from such principles.

1. A pump assembly comprising:
a stator housing;
an electric drive motor arranged in the stator housing;
an electronics housing arranged on an outer side of the stator housing, wherein the electronics housing has a section of an outer wall which does not face the stator housing and the section of outer wall comprises at least one opening; and
a heat distributor arranged in an inside of the electronics housing and situated at or adjacent to the opening.

2. A pump assembly according to claim 1, wherein the electronics housing is situated on a radial side or axial side of the stator housing.

3. A pump assembly according to claim 2, wherein:
the electronics housing is applied onto the stator housing at the axial side and comprises at least one section projecting in a radial direction beyond an outer periphery of the stator housing; and
the opening is formed in the outer wall of the electronics housing, said outer wall being situated on an axial side of the electronics housing which faces the stator housing, in a region of the projecting section,

4. A pump assembly according to claim 1, further comprising a seal, wherein:
the heat distributor closes the opening; and
the seal (94; 148) is arranged between the heat distributor and the outer wall surrounding the opening.

5. A pump assembly according to claim 1, wherein the heat distributor is situated completely in the inside of the electronics housing or extends outwards through the opening out of the inside of the electronics housing.

6. A pump assembly according to claim 1, wherein the heat distributor is designed as a molded component or as a formed part of sheet metal.

7. A pump assembly according to claim 1, wherein the heat distributor in the region of the opening is essentially exposed to the outer side or is covered maximally by 50% of it's a base surface.

8. A pump assembly according to claim 1, wherein a region of the heat distributor in the inside of the electronics housing is connected in a thermally conductive manner to at least one electronic component, wherein the region is situated at least partly outside an outer contour of the opening.

9. A pump assembly according to claim 1, wherein the heat distributor on the outer side of the electronics housing is distanced to the stator housing.

10. A pump assembly according to claim 1, wherein the outer wall of the electronics housing, in which the opening is formed, comprises a step which projects into the inside of the electronics housing and in which the opening is situated.

11. A pump assembly according to claim 10, wherein the step on the outer side of the electronics housing forms a first indentation, in which the heat distributor is situated.

12. A pump assembly according to claim 1, wherein the heat distributor is situated completely within the axial extension of a peripheral wall of the electronics housing.

13. A pump assembly according to claim 1, wherein:
the heat distributor in the inside of the electronics housing bears in a thermally conductive manner on at least one electronic component which is arranged on a circuit board; and
the circuit board extends essentially parallel to the outer wall of the electronics housing, in which outer wall the opening is formed.

14. A pump assembly according to claim 10, wherein a receiving space (122) is present laterally of the step projecting into the inside of the electronics housing, in which receiving space the outer wall of the electronics housing is distanced further, in an axial direction to a circuit board situated in the electronics housing, than in the region of the step, and in which at least one electronic component with a greater construction height is arranged.

15. A pump assembly according to claim 14, wherein the receiving space is situated between the step and a peripheral wall of the electronics housing, on a side of the step which is away from a rotation axis (X) of the drive motor.

16. A pump assembly according to claim 1, further comprising a connection element comprising a first plug connector which is connected to a corresponding plug contact on a circuit board arranged in the inside of the electronics housing, and a second plug connector for the connection of an electrical connection lead, wherein the connection element is preferably arranged on an outer side of the electronics housing and with its first plug connector engages through an opening in an outer wall of the electronics housing, into the inside of this electronics housing.

17. A pump assembly according to claim 16, wherein an outer wall of the electronics housing comprises an inwardly directed second indentation, in which the connection element is arranged, wherein the indentation is situated at a corner of the electronics housing.

18. A pump assembly according to claim 1, further comprising: and earth contact and a circuit board wherein the heat distributor is electrically conductively connected with the earth contact to the circuit board and the circuit board is situated on the inside of the electronics housing via a screw (112).

19. A pump assembly according to claim 1, wherein the pump assembly comprises is a case of a circulation pump assembly, and the drive motor is a wet-running drive motor.
